(19) United States
(12) Patent Application Publication
(10) Pub. No.: US 2020/0060329 A1
(43) Pub. Date: Feb. 27, 2020

(54) COMPOSITION USEFUL TO SIMULATE TOBACCO AROMA

(71) Applicant: British American Tobacco (Investments) Limited, London (GB)

(72) Inventors: Klaus Mathie, London (GB); Jennifer Cross, London (GB)

(21) Appl. No.: 16/347,131

(22) PCT Filed: Nov. 1, 2017
(86) PCT No.: PCT/GB2017/053287

§ 371 Date: May 2, 2019

(30) Foreign Application Priority Data
Nov. 4, 2016 (GB) 1618587.8

(51) Int. Cl. A24B 15/16; A24F 47/00; C11B 9/00

(52) U.S. Cl. CPC A24B 15/167; A24F 47/008; C11B 9/0061; C11B 9/0034; C11B 9/008; C11B 9/0019

(57) ABSTRACT

The present invention relates to a synthetic composition which may be used to simulate a tobacco aroma. The composition comprises two or more of components A, B, C, D and/or E. As a result of providing a synthetic composition which may be used to simulate a tobacco aroma, it is possible to provide a more simple composition compared to tobacco extracts.

### FIELD OF THE INVENTION

The present invention relates a composition, in particular a synthetic composition, with a tobacco-like aroma. The invention also relates to the use of said composition, a formulation comprising said composition, containers containing the formulation, methods of generating an aerosol using the formulation and the use of said formulation.

### BACKGROUND

Tobacco is produced from the leaves of the tobacco plant. Generally, the leaves of the tobacco plant are harvested and then cured which leads to a change in the composition of the tobacco leaf. The leaf then undergoes further processing in order to produce tobacco. Tobacco has a characteristic aroma which results from its complex range of constituents.

Recently, devices have been developed which allow a user to replicate parts of the smoking experience without having to use conventional cigarettes. In particular, devices such as e-cigarettes have been developed which allow a user to generate an artificial aerosol which can then be inhaled to replicate the smoking experience. The aerosol is typically produced by vaporising a liquid which comprises water, nicotine and an aerosol forming component such as glycerol. The vaporisation occurs via a heater (or other atomization means) which is powered by a power source such as a battery.

Other devices are also available which seek to replicate the smoking experience without having to use conventional cigarettes. These devices may be referred to as tobacco heating devices, since they generally have the capacity to heat tobacco, but not combust it.

Collectively, e-cigarettes and tobacco heating devices may be referred to as aerosol delivery devices. However, one potential drawback with such aerosol delivery devices, in particular with e-cigarettes, is that they may fail to completely replicate the sensorial experience normally associated with smoking a conventional cigarette which users of conventional cigarettes may find less desirable.

As a result, it would be desirable to provide means for improving the sensorial experience delivered by aerosol delivery devices.

### SUMMARY OF THE INVENTION

The present invention relates to a synthetic composition which is able to simulate the aromatic profile of tobacco. The synthetic composition can also be described as having a tobacco-like aroma.

Accordingly, in a first aspect the present invention relates to a synthetic composition comprising two or more components selected from components A, B, C, D and E wherein:

A is at least one compound of formula I

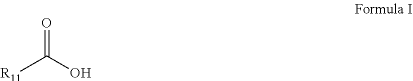

wherein R₁₁ is a saturated —C₁-C₆ hydrocarbon group;
B is at least one compound of formula II

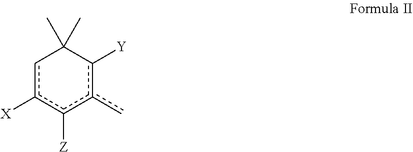

wherein Y is a group selected from —R₉(C═O)R₁₀, or a saturated or unsaturated —C₁-C₆ hydrocarbon group optionally substituted with one or more hydroxyl groups;
R₉ is a bond or a saturated or unsaturated —C₁-C₆ hydrocarbon group;
R₁₀ is —H or a saturated or unsaturated —C₁-C₆ hydrocarbon group;
Z and X are both independently selected from —H and —R₃;
R₃ is selected from a saturated or unsaturated —C₁-C₆ hydrocarbon group, a keto group, or -L-(C═O)R₁₃,
L is either a bond or —C₁-C₆ hydrocarbon group,
R₁₃ is a saturated or unsaturated —C₁-C₆ hydrocarbon group; [symbol]
represents an optional double bond;
C is at least one compound of formula III

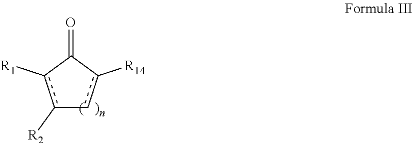

wherein the ring system of formula III may optionally contain an oxygen atom;
n is 1 or 2; [symbol]
represents an optional double bond;
R₁ is —OH, —C₁-C₆-alkoxy, or —OCOR₁₂;
R₁₂ is a saturated or unsaturated —C₁-C₆ hydrocarbon group;
R₂ and R₁₄ are independently selected from H and an optionally substituted saturated or unsaturated —C₁-C₆ hydrocarbon group;
D is at least one compound of formula IV

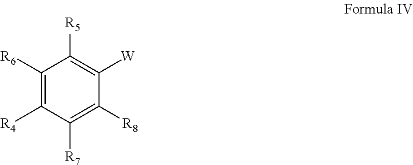

wherein W is —OH, —C₁-C₆—OH, —(C═O)H, —C₁-C₃—(C═O)H, —O(C═O)H, —O(C═O)CH₃, C₁-C₆ alkoxy or —R₁₅(C═O)OR₁₆;
R₁₅ is a saturated or unsaturated —C₁-C₆ hydrocarbon group;
R₁₆ is —H or a saturated or unsaturated —C₁-C₆ hydrocarbon group;
R₄ to R₈ are each independently —H, —OH, C₁-C₆ alkoxy, or a saturated or unsaturated —C₁-C₆ hydrocarbon group;
E is at least one compound selected from the group consisting of:
3-methyl-2,4-nonandione and 5,6,7-Trimethylocta-2,5-dien-4-one.

In a further aspect the present invention relates to the use of a synthetic composition as defined herein to simulate a tobacco aroma.

In a further aspect of the present invention, there is provided a formulation comprising the synthetic composition as defined herein, wherein the formulation further comprises at least one of:
nicotine; and/or
a carrier.

In a further aspect the present invention relates to the use of a formulation as defined herein for simulating a tobacco aroma.

In a further aspect, the present invention relates to methods of preparing the above mentioned synthetic composition.

For ease of reference, these and further aspects of the present invention are now discussed under appropriate section headings. However, the teachings under each section are not necessarily limited to each particular section.

### DETAILED DESCRIPTION

The term “hydrocarbon” means any one of an alkyl group alkenyl or alkynyl group. The term hydrocarbon also includes those groups but wherein they have been optionally substituted. In one embodiment, the hydrocarbon is un-substituted unless specified otherwise. If the hydrocarbon is a branched structure having substituent(s) thereon, then the substitution may be on either the hydrocarbon backbone or on the branch; alternatively the substitutions may be on the hydrocarbon backbone and on the branch. Examples of suitable substitutions include hydroxyl groups.

Reference to an unsaturated hydrocarbon includes hydrocarbon chains containing one or more C═C bonds. In this regard, such C═C bonds may be in the cis or trans configuration unless stated otherwise.

In some aspects of the present invention, one or more hydrocarbon groups is independently selected from C₁-C₁₀ alkyl groups, such as C₁-C₉, C₁-C₈, C₁-C₇, C₁-C₆, C₁-C₅, C₂-C₁₀, C₃-C₁₀, C₄-C₁₀, C₅-C₁₀, C₁-C₅, C₁-C₄, C₁-C₃ alkyl groups. Typical alkyl groups include C₁ alkyl, C₂ alkyl, C₃ alkyl, C₄ alkyl, C₅ alkyl, C₇ alkyl, and C₈ alkyl.

In some aspects of the present invention, one or more hydrocarbon groups is independently selected from alkene groups. Typical alkene groups include C₁-C₁₀, alkene groups, such as C₁-C₉, C₁-C₈, C₁-C₇, C₁-C₆, C₁-C₅, C₂-C₁₀, C₃-C₁₀, C₄-C₁₀, C₅-C₁₀, C₁-C₅, C₁-C₄, or C₁-C₃ alkene groups, such as C₁, C₂, C₃, C₄, C₅, C₆, or C₇ alkene groups. In a preferred aspect the alkene group contains 1, 2 or 3 C═C bonds. In a preferred aspect the alkene group contains 1 C═C bond. In some preferred aspects at least one C═C bond or the only C═C bond is to the terminal C of the alkene chain, that is the bond is at the distal end of the chain to the ring system.

Reference to [symbol] in the present description refers to the presence of an optional double bond between two carbon atoms.

### Compound A

A is at least one compound of formula I

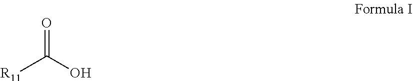

wherein R₁₁ is a saturated —C₁-C₆ hydrocarbon group.

In one embodiment, R₁₁ is a linear —C₁-C₆ hydrocarbon group. In one embodiment, R₁₁ is a branched —C₁-C₆ hydrocarbon group. In one embodiment, R₁₁ is a branched —C₁-C₄ hydrocarbon group. In one embodiment, R₁₁ is a linear —C₃-C₆ hydrocarbon group. In one embodiment, R₁₁ is a branched —C₃-C₆ hydrocarbon group.

In one embodiment, R₁₁ is selected from C₁, C₂, C₃ alkyl, C₄ alkyl, C₅ alkyl and C₆ alkyl. In one embodiment, R₁₁ is C₁ alkyl. In one embodiment, R₁₁ is n-propyl, n-butyl or n-pentyl. In one embodiment, R₁₁ is iso-propyl, iso-butyl, sec-butyl, or tert-butyl. In one embodiment, R₁₁ is a branched pentyl group. In one embodiment, compound A is 3-methylbutanoic acid, also known as isovaleric acid. In one embodiment, compound A is acetic acid. In one embodiment, compound A is 3-methyl pentanoic acid, also known as 3-methylvaleric acid. In one embodiment, compound A is 2-methylbutanoic acid. In one embodiment, compound A is butyric acid, also known as butanoic acid.

In one embodiment, A is at least two different compounds of formula I. In one embodiment, A is at least three different compounds of formula I. In one embodiment, A is at least four different compounds of formula I.

In one embodiment, A is at least acetic acid and 2-methylbutanoic acid.

### Compound B

B is at least one compound of formula II

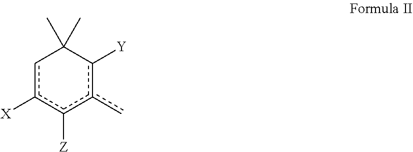

wherein Y is —R₉(C═O)R₁₀, or a saturated or unsaturated —C₁-C₆ hydrocarbon group optionally substituted with one or more hydroxyl groups;
R₉ is a bond or a saturated or unsaturated —C₁-C₆ hydrocarbon group;
R₁₀ is —H or a saturated or unsaturated —C₁-C₆ hydrocarbon group;
Z and X are both independently selected from —H and —R₃;
R₃ is selected from a saturated or unsaturated —C₁-C₆ hydrocarbon group, a keto group, or -L-(C═O)R₁₃; [symbol]
represents an optional double bond;
L is either a bond or —C₁-C₆ hydrocarbon group; and
R₁₃ is a saturated or unsaturated —C₁-C₆ hydrocarbon group.

In one embodiment, compound B is of formula IIa

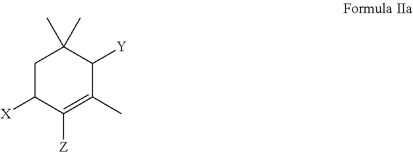

In one embodiment, compound B is of formula IIb

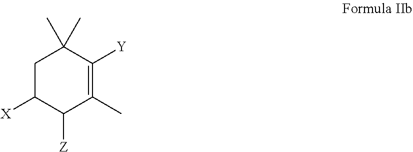

In one embodiment, compound B is of formula IIc

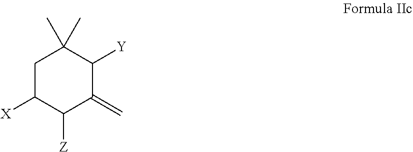

In one embodiment, compound B is of formula IId

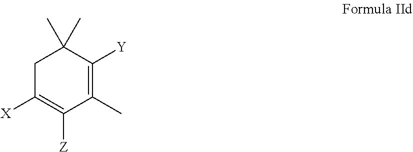

In any of the above formulas IIa, IIb, IIc or IId, Z, X and Y are as defined for formula II.

In one embodiment, Y is a saturated or unsaturated —C₁-C₆ hydrocarbon group substituted with one or more hydroxyl groups. In one embodiment, Y is an unsubstituted saturated or unsaturated —C₁-C₆ hydrocarbon group.

In one embodiment, Y is a C₄ linear alkene comprising one or two unsaturated bonds.

In one embodiment, Y is Y is —R₉(C═O)R₁₀.

In one embodiment, X is —R₃ and Z is —H.

In one embodiment, Z is —R₃ and X is —H.

In one embodiment, both Z and X are H.

In one embodiment, R₁₃ is an unsaturated —C₁-C₄ hydrocarbon group. In one embodiment, R₁₃ is an unsaturated —C₃ hydrocarbon group. In one embodiment, R₁₃ is a —CH═CHCH₃ group. In one embodiment, R₁₃ is a —CH₂CH═CH₂ group. In one embodiment, R₁₃ is an unsaturated —C₄ hydrocarbon group. In one embodiment, R₁₃ is a —CH₂CH₂CH═CH₂ group.

In one embodiment, compound B is of formula IIa, X is R₃, Z is —H, and R₁₃ is an unsaturated —C₃ hydrocarbon group. In one embodiment, compound B is of formula IIa, X is R₃, Z is —H, and R₁₃ is a —CH═CHCH₃ group.

In one embodiment, compound B is of formula IIb, X is R₃, Z is —H, and R₁₃ is an unsaturated —C₃ hydrocarbon group. In one embodiment, compound B is of formula IIb, X is R₃, Z is —H, and R₁₃ is a —CH═CHCH₃ group.

In one embodiment, compound B is of formula IIc, X is R₃, Z is —H, and R₁₃ is an unsaturated —C₃ hydrocarbon group. In one embodiment, compound B is of formula IIc, X is R₃, Z is —H, and R₁₃ is a —CH═CHCH₃ group.

In one embodiment, compound B is of formula IId, X is R₃, Z is —H, and R₁₃ is an unsaturated —C₃ hydrocarbon group. In one embodiment, compound B is of formula IId, X is R₃, Z is —H, and R₁₃ is a —CH═CHCH₃ group.

In one embodiment, compound B is of formula IIa, Z is R₃, X is —H, and R₁₃ is an unsaturated —C₃ hydrocarbon group. In one embodiment, compound B is of formula IIa, Z is R₃, X is —H, and R₁₃ is a —CH═CHCH₃ group.

In one embodiment, compound B is of formula IIb, Z is R₃, X is —H, and R₁₃ is an unsaturated —C₃ hydrocarbon group. In one embodiment, compound B is of formula IIb, Z is R₃, X is —H, and R₁₃ is a —CH═CHCH₃ group.

In one embodiment, compound B is of formula IIc, Z is R₃, X is —H, and R₁₃ is an unsaturated —C₃ hydrocarbon group. In one embodiment, compound B is of formula IIc, Z is R₃, X is —H, and R₁₃ is a —CH═CHCH₃ group.

In one embodiment, compound B is of formula IId, Z is R₃, X is —H, and R₁₃ is an unsaturated —C₃ hydrocarbon group. In one embodiment, compound B is of formula IId, Z is R₃, X is —H, and R₁₃ is a —CH═CHCH₃ group.

In one embodiment, Y is —R₉(C═O)R₁₀, R₉ is a bond and R₁₀ is an unsaturated —C₁-C₆ hydrocarbon group.

In one embodiment, Y is —R₉(C═O)R₁₀, R₉ is a bond and R₁₀ is an unsaturated —C₃-C₆ hydrocarbon group. In one embodiment, Y is —R₉(C═O)R₁₀, R₉ is a bond and R₁₀ is an unsaturated —C₃ hydrocarbon group, such as a —CH═CHCH₃ group or —CH₂CH═CH₂ group.

In one embodiment, Y is —R₉(C═O)R₁₀, R₉ is a bond and R₁₀ is an unsaturated —C₄ hydrocarbon group, such as a —CH₂CH₂CH═CH₂ group.

In one embodiment, Y is —R₉(C═O)R₁₀, R₉ is an unsaturated —C₁-C₆ hydrocarbon group, and R₁₀ is an unsaturated —C₁-C₆ hydrocarbon group. For example, R₉ is an unsaturated —C₂ hydrocarbon group, such as a —CH═CH— group. Further, R₁₀ is for example, a —CH₃ group. In one embodiment, Y is —R₉(C═O)R₁₀, R₉ is a —CH═CH— group and R₁₀ is a —CH₃ group.

In one embodiment, compound B is of formula IIa and Y is an unsubstituted saturated or unsaturated —C₁-C₆ hydrocarbon group substituted with one or more hydroxyl groups. In a further embodiment, compound B is of formula IIa, Y is an unsubstituted saturated or unsaturated —C₁-C₆ hydrocarbon group substituted with one or more hydroxyl groups, X is —R₃ where —R₃ is a keto group, and Z is H.

In one embodiment, B is at least one compound selected from β-damascone, β-damascenone β-ionone, α-ionone, α-ionol, β-cyclocitral, and safranal.

In one embodiment, B is at least two different compounds of formula II. In one embodiment, B is at least three different compounds of formula II. In one embodiment, B is at least four different compounds of formula II.

In one embodiment, B is at least two compounds selected from β-damascone, β-damascenone β-ionone, α-ionone, α-ionol, β-cyclocitral, and safranal. In one embodiment, B is at least β-damascone, β-damascenone and β-ionone.

### Compound C

C is at least one compound of formula III

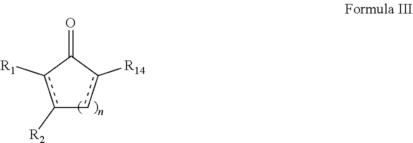

wherein the ring system of formula III may optionally contain an oxygen atom;
n is 1 or 2; [symbol]
represents an optional double bond;
R₁ is —OH, C₁-C₆-alkoxy or —OCOR₁₂;
R₁₂ is a saturated or unsaturated —C₁-C₆ hydrocarbon group;
R₂ and R₁₄ are independently selected from H and an optionally substituted saturated or unsaturated —C₁-C₆ hydrocarbon group.

In one embodiment, n is 1 and the ring system is therefore a 5 membered ring.

In one embodiment, where n is 1, compound C is at least one compound of formula IIIa

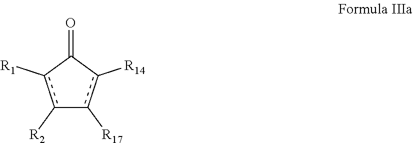

wherein R₁₇ is H or a saturated or unsaturated —C₁-C₆ hydrocarbon group and wherein R₁, R₂, and R₁₄ and the optional presence of an oxygen atom in the ring are as for formula III.

In one embodiment, the ring of formula IIIa contains an oxygen atom. In one embodiment, formula IIIa has the following structure:

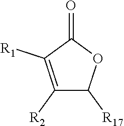

wherein R₁₇ is H or a saturated or unsaturated —C₁-C₆ hydrocarbon group and wherein R₁ and R₂ are as for formula III.

In one embodiment, R₁ is —OH, R₂ is —CH₃ and R₁₇ is —CH₃.

In one embodiment, formula IIIa has the following structure:

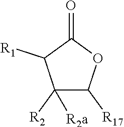

wherein R₁₇ is H or a saturated or unsaturated —C₁-C₆ hydrocarbon group and wherein R₁ and R₂ are as for formula III; and R₂ₐ is H or a saturated or unsaturated —C₁-C₆ hydrocarbon group.

In one embodiment for component C, n is 2 and the ring system is therefore a 6 membered ring.

In one embodiment, where n is 2, C is at least one compound of formula IIIb

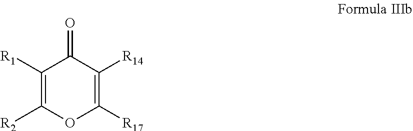

wherein R₁₇ is H or a saturated or unsaturated —C₁-C₆ hydrocarbon group and wherein R₁, R₂, and R₁₄ and are as for formula III.

In one embodiment, R₁ is —OH.

In one embodiment, R₂ is —CH₃.

In one embodiment, R₁ is —OH and R₂ is —CH₃.

In one embodiment, R₂ is a saturated —C₂-C₄ hydrocarbon group. In one embodiment, R₂ is a C₂ alkyl or C₃ alkyl. In one embodiment, R₂ is a C₂ alkyl.

In one embodiment, R₁ is —OH and R₂ is a C₂ alkyl.

In one embodiment, R₁ is —OCOR₁₂, wherein R₁₂ is selected from —CH₃ or a saturated —C₂-C₄ hydrocarbon group.

In one embodiment, R₁₂ is —CH₃.

In one embodiment, R₁₂ is a saturated —C₂-C₄ hydrocarbon group. In one embodiment, R₁₂ is a C₂ alkyl or C₃ alkyl. In one embodiment, R₁₂ is a C₂ alkyl. In one embodiment, R₁₂ is a C₃ alkyl. In one embodiment, R₁₂ is iso-propyl. In one embodiment, R₁₂ is n-propyl.

In one embodiment, R₁ is —OCOR₁₂, wherein R₁₂ is a C₂ alkyl or C₃ alkyl, and R₂ is —CH₃. In one embodiment, R₁ is —OCOR₁₂, wherein R₁₂ is a C₃ alkyl, and R₂ is —CH₃. In one embodiment, R₁ is —OCOR₁₂, wherein R₁₂ is iso-propyl, and R₂ is —CH₃. In one embodiment, R₁ is —OCOR₁₂, wherein R₁₂ is a n-propyl, and R₂ is —CH₃.

In one embodiment, C is at least two different compounds of formula III. In one embodiment, C is at least three different compounds of formula III. In one embodiment, C is at least four different compounds of formula III.

In one embodiment, C is at least one compound of formula IIIb and one compound of formula IIIc. In one embodiment, C is at least two compounds selected from maltol, ethyl maltol and sotolone.

### Compound D

D is at least one compound of formula IV

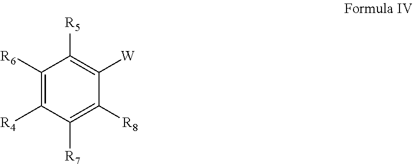

wherein W is —OH, —C₁-C₆—OH, —(C═O)H, —C₁-C₃—(C═O)H, —C₁-C₆—O(C═O)CH₃, C₁-C₆ alkoxy or —R₁₅(C═O)OR₁₆;
R₁₅ is a saturated or unsaturated —C₁-C₆ hydrocarbon group;
R₁₆ is —H or a saturated or unsaturated —C₁-C₆ hydrocarbon group; and
R₄ to R₈ are each independently —H, —OH, C₁-C₆ alkoxy, or a saturated or unsaturated —C₁-C₆ hydrocarbon group.

In one embodiment, W is —R₁₅(C═O)OR₁₆.

In one embodiment, W is —OH. In one embodiment, W is —C₁-C₆—OH, —(C═O)H, —C₁-C₃—(C═O)H, —O(C═O)H, —O(C═O)CH₃, C₁-C₆ alkoxy or —R₁₅(C═O)OR₁₆. In one embodiment, W is —(C═O)H. In one embodiment, W—C₁-C₃—(C═O)H. In one embodiment, W is —O(C═O)H, —O(C═O)CH₃, C₁-C₆ alkoxy or —R₁₅(C═O)OR₁₆. In one embodiment, W is —O(C═O)CH₃. In one embodiment, W is C₁-C₆ alkoxy.

In one embodiment, each of R₄ to R₈ is —H. In one embodiment, each of R₅ to R₈ are —H, and R₄ is a saturated or unsaturated —C₁-C₄ hydrocarbon group.

In one embodiment, the saturated or unsaturated —C₁-C₄ hydrocarbon group of any of R₄ to R₈ is selected from methyl, ethyl, propyl (branched or linear), and butyl (branched or linear).

In one embodiment, the —C₁-C₄ hydrocarbon group of any of R₄ to R₈ is unsaturated.

In one embodiment, R₁₅ is —CH₂—.

In one embodiment, R₁₆ is H.

In one embodiment, R₁₆ is a saturated or unsaturated —C₁-C₄ hydrocarbon group. In one embodiment, R₁₆ is a saturated —C₁-C₄ hydrocarbon group. In one embodiment, R₁₆ is an unsaturated —C₁-C₄ hydrocarbon group. In one embodiment, R₁₆ is methyl, ethyl, n-pentyl, or n-butyl. In one embodiment, R₁₆ is branched pentyl, or branched butyl.

In one embodiment, R₁₅ is —CH₂— and R₁₆ is H.

In one embodiment, each of R₄ to R₈ is —H, R₁₅ is —CH₂— and R₁₆ is H.

In one embodiment, W is —OH.

In one embodiment, W is —OH, and at least one of R₄ to R₈ is C₁-C₆ alkoxy. In one embodiment, W is —OH, at least one of R₄ to R₈ is C₁-C₆ alkoxy; and at least one of R₄ to R₈ is a saturated or unsaturated —C₁-C₆ hydrocarbon group.

In one embodiment, D is at least two different compounds of formula IV. In one embodiment, D is at least three different compounds of formula IV. In one embodiment, D is at least four different compounds of formula IV.

In one embodiment, D is at least one compound wherein W is —OH and one compound wherein W is is —R₁₅(C═O)OR₁₆.

### Preferable Aspects

In one embodiment, the synthetic composition comprises three or more components selected from components A, B, C, D and E, wherein each of A, B, C, D and E are as defined herein.

In one embodiment, the synthetic composition comprises four or more components selected from components A, B, C, D and E, wherein each of A, B, C, D and E are as defined herein.

In one embodiment, the synthetic composition comprises at least components A, B, C, and D wherein each of A, B, C, and D are as defined herein.

In one embodiment, the synthetic composition comprises a component from each of components A, B, C, D and E, wherein each of A, B, C, D and E are as defined herein.

In one embodiment, the synthetic composition comprises at least components A, B, C, and D, as defined above, and further wherein:
the at least one compound of component C is a compound wherein R₁ is —OH or —OCOR₁₂; R₁₂ is a saturated or unsaturated —C₁-C₆ hydrocarbon group; R₂ and R₁₄ are independently a saturated or unsaturated —C₁-C₆ hydrocarbon group;
the at least one compound of component B is a compound wherein Y is —R₉(C═O)R₁₀, or a saturated or unsaturated —C₁-C₆ hydrocarbon group substituted with one or more hydroxyl groups; R₉ is a bond or a saturated or unsaturated —C₁-C₆ hydrocarbon group; R₁₀ is —H or a saturated or unsaturated —C₁-C₆ hydrocarbon group; Z and X are different and both independently selected from —H and —R₃; R₃ is selected from a saturated or unsaturated —C₁-C₆ hydrocarbon group, a keto group, or -L-(C═O)R₁₃, L is either a bond or —C₁-C₆ hydrocarbon group, and R₁₃ is a saturated or unsaturated —C₁-C₆ hydrocarbon group;
the at least one compound of component D is a compound wherein R₄ to R₈ are each —H; W is a group —R₉(C═O)OR₁₀, wherein R₉ is —CH₂— and R₁₀ is H; and
the at least one compound of component A is a compound wherein R₁₁ is a saturated —C₁-C₆ hydrocarbon group.

In one embodiment, the synthetic composition comprises at least components A, B, C, and D, as defined above, and further wherein:
the at least one compound of component C is a compound wherein R₁ is —OH or —OCOR₁₂; R₁₂ is a saturated or unsaturated —C₁-C₆ hydrocarbon group; R₂ and R₁₄ are independently a saturated or unsaturated —C₁-C₆ hydrocarbon group;
the at least one compound of component B is a compound wherein Y is —R₉(C═O)R₁₀, or a saturated or unsaturated —C₁-C₆ hydrocarbon group substituted with one or more hydroxyl groups; R₉ is a bond or a saturated or unsaturated —C₁-C₆ hydrocarbon group; R₁₀ is —H or a saturated or unsaturated —C₁-C₆ hydrocarbon group; Z and X are different and both independently selected from —H and —R₃; R₃ is selected from a saturated or unsaturated —C₁-C₆ hydrocarbon group, a keto group, or -L-(C═O)R₁₃, L is either a bond or —C₁-C₆ hydrocarbon group, and R₁₃ is a saturated or unsaturated —C₁-C₆ hydrocarbon group;
the at least one compound of component D is a compound wherein W is —OH, C₁-C₆ alkoxy or —R₁₅(C═O)OR₁₆; R₁₅ is a saturated or unsaturated —C₁-C₆ hydrocarbon group; R₁₆ is —H or a saturated or unsaturated —C₁-C₆ hydrocarbon group; R₄ to R₈ are each independently —H, —OH, C₁-C₆ alkoxy, or a saturated or unsaturated —C₁-C₆ hydrocarbon group;
the at least one compound of component A is a compound wherein R₁₁ is iso-butyl.

In one embodiment, the synthetic composition comprises at least components A, B, C, and D, as defined above, and further wherein:
the at least one compound of component C is a compound wherein R₁ is —OH or —OCOR₁₂; R₁₂ is a saturated or unsaturated —C₁-C₆ hydrocarbon group; R₂ and R₁₄ are independently a saturated or unsaturated —C₁-C₆ hydrocarbon group;
the at least one compound of component B is a compound of formula lib, wherein Y is —R₉(C═O)R₁₀, R₉ is a bond or a saturated or unsaturated —C₁-C₆ hydrocarbon group; R₁₀ is —H or a saturated or unsaturated —C₁-C₆ hydrocarbon group; Z and X are different and both independently selected from —H and —R₃; R₃ is selected from a saturated or unsaturated —C₁-C₆ hydrocarbon group, a keto group, or -L-(C═O)R₁₃, L is either a bond or —C₁-C₆ hydrocarbon group, R₁₃ is a saturated or unsaturated —C₁-C₆ hydrocarbon group;
the at least one compound of component D is a compound wherein W is —OH, C₁-C₆ alkoxy or —R₁₅(C═O)OR₁₆; R₁₅ is a saturated or unsaturated —C₁-C₆ hydrocarbon group; R₁₆ is —H or a saturated or unsaturated —C₁-C₆ hydrocarbon group; R₄ to R₈ are each independently —H, —OH, C₁-C₆ alkoxy, or a saturated or unsaturated —C₁-C₆ hydrocarbon group;
the at least one compound of component A is a compound wherein R₁₁ is a saturated —C₁-C₆ hydrocarbon group.

In one embodiment, the synthetic composition comprises at least components A, B, C, and D, as defined above, and further wherein:
the at least one compound of component C is a compound of formula IIIb, wherein R₁ is —OH; R₂ is selected from a saturated or unsaturated —C₁-C₆ hydrocarbon group;
the at least one compound of component B is a compound wherein Y is —R₉(C═O)R₁₀, or a saturated or unsaturated —C₁-C₆ hydrocarbon group substituted with one or more hydroxyl groups; R₉ is a bond or a saturated or unsaturated —C₁-C₆ hydrocarbon group; R₁₀ is —H or a saturated or unsaturated —C₁-C₆ hydrocarbon group; Z and X are different and both independently selected from —H and —R₃; R₃ is selected from a saturated or unsaturated —C₁-C₆ hydrocarbon group, a keto group, or -L-(C═O)R₁₃, L is either a bond or —C₁-C₆ hydrocarbon group, and R₁₃ is a saturated or unsaturated —C₁-C₆ hydrocarbon group;
the at least one compound of component D is a compound wherein W is —OH, C₁-C₆ alkoxy or —R₁₅(C═O)OR₁₆; R₁₅ is a saturated or unsaturated —C₁-C₆ hydrocarbon group; R₁₆ is —H or a saturated or unsaturated —C₁-C₆ hydrocarbon group; R₄ to R₈ are each independently —H, —OH, C₁-C₆ alkoxy, or a saturated or unsaturated —C₁-C₆ hydrocarbon group; the at least one compound of component A is a compound wherein R₁₁ is a saturated —C₃-C₅ hydrocarbon group.

### Further Preferred Aspects

In one embodiment, the synthetic composition comprises multiple compounds falling within any one of the above definitions for components A, B, C, D and E. For example, the synthetic composition may comprise two or more different component A compounds, in addition to at least one component from one or more of components B, C, D and E. In one embodiment, the synthetic composition may comprise two or more different component B compounds, in addition to at least one component from one or more of components A, C, D and E. In one embodiment, the synthetic composition may comprise two or more different component C compounds, in addition to at least one component from one or more of components A, B, D and E. In one embodiment, the synthetic composition may comprise two or more different component D compounds, in addition to at least one component from one or more of components A, B, C and E.

In one embodiment, the synthetic composition may comprise two or more different compounds from multiple component groups A, B, C or D. Thus, the synthetic composition may comprise two or more different component A compounds, two or more different component B compounds, two or more different component C compounds, two or more different component D compounds, and/or two or more different component E compounds.

Accordingly, in one embodiment, the synthetic composition comprises at least four compounds selected from any of component groups A, B, C or D. In one embodiment, the synthetic composition comprises at least five compounds selected from any of component groups A, B, C or D. In one embodiment, the synthetic composition comprises at least six compounds selected from any of component groups A, B, C or D. In one embodiment, the synthetic composition comprises at least seven compounds selected from any of component groups A, B, C or D. In one embodiment, the synthetic composition comprises at least eight compounds selected from any of component groups A, B, C or D. In one embodiment, the synthetic composition comprises at least nine compounds selected from any of component groups A, B, C or D. In one embodiment, the synthetic composition comprises at least ten compounds selected from any of component groups A, B, C or D. In one embodiment, the synthetic composition comprises at least eleven compounds selected from any of component groups A, B, C or D. In one embodiment, the synthetic composition comprises at least twelve compounds selected from any of component groups A, B, C or D. In one embodiment, the synthetic composition comprises at least thirteen compounds selected from any of component groups A, B, C or D. In one embodiment, the synthetic composition comprises at least fourteen compounds selected from any of component groups A, B, C or D. In one embodiment, the synthetic composition comprises at least fifteen compounds selected from any of component groups A, B, C or D.

In one embodiment, the composition comprises at least one compound from each component group A, B, C and D, such that the composition comprises at least four compounds. In one embodiment, the composition comprises at least one compound from each component group A, B, C and D, such that the composition comprises at least five compounds. In one embodiment, the composition comprises at least one compound from each component group A, B, C and D, such that the composition comprises at least six compounds. In one embodiment, the composition comprises at least one compound from each component group A, B, C and D, such that the composition comprises at least seven compounds. In one embodiment, the composition comprises at least one compound from each component group A, B, C and D, such that the composition comprises at least eight compounds. In one embodiment, the composition comprises at least one compound from each component group A, B, C and D, such that the composition comprises at least nine compounds. In one embodiment, the composition comprises at least one compound from each component group A, B, C and D, such that the composition comprises at least ten compounds. In one embodiment, the composition comprises at least one compound from each component group A, B, C and D, such that the composition comprises at least eleven compounds. In one embodiment, the composition comprises at least one compound from each component group A, B, C and D, such that the composition comprises at least twelve compounds. In one embodiment, the composition comprises at least one compound from each component group A, B, C and D, such that the composition comprises at least thirteen compounds. In one embodiment, the composition comprises at least one compound from each component group A, B, C and D, such that the composition comprises at least fourteen compounds. In one embodiment, the composition comprises at least one compound from each component group A, B, C and D, such that the composition comprises at least fifteen compounds.

In one embodiment, where two or more different component A compounds are present, they may be selected from two or more of the group consisting of acetic acid, 3-methylbutanoic acid, 3-methyl pentanoic acid, 2-methylbutanoic acid, and butyric acid. In one embodiment, where two or more different component A compounds are present, they are at least butyric acid and 3-methylbutanoic acid.

In one embodiment, where two or more different component B compounds are present, one compound is of formula IIb and one compound is of formula IId.

In one embodiment, where two or more different component C compounds are present, one compound is such that R₁ is —OH and R₂ is —CH₃, and one compound is such that R₁ is —OH and R₂ is ethyl.

In one embodiment, where two or more different component D compounds are present, one compound is such that W is R₁₅(C═O)OR₁₆ and the other is such that W is —OH.

The composition of the present invention may also comprise, in addition to components A, B, C and D, one or more of the following compounds falling within component E: 3-methyl-2,4-nonandione and 5,6,7-Trimethylocta-2,5-dien-4-one.

The compounds present in the synthetic composition of the present invention may be present in certain ratios in mg/ml of the total composition.

In one embodiment, components A, C and D are present in the synthetic composition in a particular ratio relative to component B, wherein the amount of each component is in mg/ml of the total composition.

In one embodiment, the ratio of component A:B for those component A components where R₁₁ is not methyl, is from 1 to 25:1. In one embodiment, the ratio of component A:B for those component A components where R₁₁ is not methyl, is from 1 to 15:1. In one embodiment, the ratio of component A:B for those component A components where R₁₁ is not methyl, is from 2 to 10:1. In one embodiment, the ratio of component A:B for those component A components where R₁₁ is methyl, is greater than 100:1. In one embodiment, the ratio of component A:B for those component A components where R₁₁ is methyl, is greater than 150:1. In one embodiment, the ratio of component A:B for those component A components where R₁₁ is methyl, is greater than 200:1.

In one embodiment, the ratio of component C:B is from 2 to 65:1. In one embodiment, the ratio of component C:B is from 3 to 65:1. In one embodiment, the ratio of component C:B is from 5 to 65:1. In one embodiment, the ratio of component C:B is from 10 to 65:1. In one embodiment, the ratio of component C:B is from 15 to 65:1. In one embodiment, the ratio of component C:B is from 25 to 40:1. In one embodiment, the ratio of component C:B is from 30 to 40:1. In one embodiment, the ratio of component C:B is from 50 to 65:1. In one embodiment, the ratio of component C:B is from 50 to 60:1. In one embodiment, the ratio of component C:B is from 15 to 25:1. In one embodiment, the ratio of component C:B is from 3 to 20:1.

In one embodiment, the ratio of component D:B is from 5 to 150:1. In one embodiment, the ratio of component D:B is from 5 to 140:1. In one embodiment, the ratio of component D:B is from 10 to 40:1. In one embodiment, the ratio of component D:B is from 10 to 35:1. In one embodiment, the ratio of component D:B is from 15 to 35:1. In one embodiment, the ratio of component D:B is from 15 to 25:1. In one embodiment, the ratio of component D:B is from 10 to 20:1. In one embodiment, the ratio of component D:B is from 5 to 10:1.

In this regard, reference to a ratio for a particular component means that component in total. For example, where two or more different compounds are present for component A, the ratio for component A relates to the total amount of the compounds for that component.

In one embodiment, component B includes a compound according to formula IIb wherein Y is R₃, Z is —H, and R₁₃ is a —CH═CHCH₃ group. In this embodiment, the components A, C and D may be present in particular ratios relative to this specific compound of component B. In particular, component A may be present in a ratio of from 1 to 20:1, for example from 1 to 5:1, or from 15 to 20:1. Further, component C may be present in a ratio of from 5 to 50:1, for example from 5 to 15:1, or from 35 to 45:1. Further, component D may be present in a ratio of from 15 to 25:1, for example from 18 to 22:1.

In one embodiment, components A, C and D are present in the synthetic composition, relative to component B (total B components), in the following amounts:
A:B is from 5 to 10:1;
C:B is from 5 to 10:1; and
D:B is from 10 to 15:1

In one embodiment, components A, C and D are present in the synthetic composition, relative to component B (total B components), in the following amounts:
A:B is from 1 to 5:1;
C:B is from 1 to 5:1; and
D:B is from 5 to 10:1

In one embodiment, components A, C and D are present in the synthetic composition, relative to component B (total B components), in the following amounts:
A:B is from 5 to 10:1;
C:B is from 15 to 25:1; and
D:B is from 5 to 10:1

In one embodiment, components A, C and D are present in the synthetic composition, relative to component B (total B components), in the following amounts:
A:B is from 5 to 10:1;
C:B is from 30 to 40:1; and
D:B is from 15 to 25:1

In one embodiment, components A, C and D are present in the synthetic composition, relative to component B (total B components), in the following amounts:
A:B is from 1 to 5:1;
C:B is from 30 to 40:1; and
D:B is from 5 to 15:1

In one embodiment, component B makes up from 1 to 10% w/v of the total for components A, B, C and D present in the synthetic composition. In one embodiment, component B makes up from 2 to 5% w/v of the total for components A, B, C and D present in the synthetic composition.

In one embodiment, components B, C and D are present in the synthetic composition in a particular ratio relative to component A, wherein the amount of each component is in mg/ml of the total composition.

In one embodiment, the ratio of component C:A is from 0.005 to 0.2:1. In one embodiment, the ratio of component C:A is from 0.006 to 0.015:1. In a further embodiment, the ratio of component C:A for those component A components where R₁₁ is not methyl, is from 2 to 27:1.

In one embodiment, the ratio of component D:A is from 0.01 to 0.3:1. In one embodiment, the ratio of component D:A is from 0.02 to 0.2:1. In one embodiment, the ratio of component D:A is from 0.05 to 0.1:1. In a further embodiment, the ratio of component D:A for those component A components where R₁₁ is not methyl, is from 5 to 70:1.

In one embodiment, components A, B and D are present in the synthetic composition in a particular ratio relative to component C, wherein the amount of each component is in mg/ml of the total composition.

In one embodiment, the ratio of component C:D is from 0.1 to 3:1. In one embodiment, the ratio of component C:D is from 0.5 to 2.5:1.

The synthetic compositions of the present invention are particularly suitable for producing a tobacco-like aroma. Furthermore, the present inventors have surprisingly found that such synthetic compositions do not need to be even partly or entirely extracted from tobacco in order to provide such an aroma.

Consequently, the synthetic compositions of the present invention are not directly derived from tobacco extracts. It is thought that during the process of extracting compounds from tobacco, other impurities (i.e. compounds in addition to the target compound), may be present. It is either impossible or very difficult to completely eliminate such impurities from an extraction which may be problematic for various reasons.

As a result, the synthetic compositions of the present invention have the distinct advantage that they need not contain additional compounds which do not contribute significantly to the provision of a tobacco-like aroma yet which may be present in a composition derived from tobacco. An example of such a compound may be a compound containing a pyrazine moiety, such as 2-ethyl-3,6-dimethylpyrazine.

In this regard, the term “synthetic” in the context of the present invention refers to a composition which is produced by combining multiple individual and/or isolated compounds to form a composition, rather than via an extraction process whereby a starting composition containing multiple compounds is extracted and then purified or otherwise modified to reduce its constituent components.

However, it is noted that the synthetic compositions of the present invention may include components which are themselves considered as isolated extracts. Thus, each component and/or compound of the composition may itself be derived from an extract, but the synthetic composition itself is then formed by combining these extracts. Generally, however, such compounds are not derived from tobacco.

In one embodiment, one or more of the components of the synthetic composition are not directly derived from tobacco. In one embodiment, none of the components of the synthetic composition are directly derived from tobacco. In one embodiment, the composition does not comprise one or more compounds being or comprising a pyrazine moiety. In one embodiment, the composition does not comprise one or more compounds being or comprising a diacetyl moiety. In one embodiment, the composition does not comprise one or more compounds being or comprising an acetoin moiety.

Owing to the synthetic composition not being derived directly from an extract, it is typically the case that the synthetic composition comprises a relatively few number of compounds. For example, in one embodiment, the synthetic composition consists essentially of two, three, four, five, six, seven, eight, nine, ten, eleven, twelve, thirteen, fourteen, or fifteen compounds. In one embodiment, the synthetic composition consists essentially of 15 or less compounds, such as 14 or less compounds, such as 13 or less compounds, such as 12 or less compounds, such as 11 or less compounds, such as 10 or less compounds, such as 9 or less compounds, such as 8 or less compounds, such as 7 or less compounds, such as 6 or less compounds, such as 5 or less compounds.

In one aspect, the present invention relates to a method of preparing a synthetic composition as defined herein, the method comprising the steps of:
combining at least one compound from one of components A, B, C, D and E as defined herein with a different compound of one of components A, B, C, D and E, wherein at least one of the compounds did not originate from a tobacco extract.

In one embodiment, where more than two different compounds falling within any of components of A, B, C, D and E are combined, at least one of the compounds is derived from a different extract from the other compounds present in the synthetic composition.

In a further aspect, the present invention relates to a method of preparing a synthetic composition as defined herein, wherein at least one compound of any of components A, B, C, D and E is not derived from an extract, the method comprising the steps of:
combining at least one of components A, B, C and D as defined herein with another of components A, B, C and D.

In one embodiment, the synthetic composition of the present invention may consist essentially of compounds of components A, B, C and D as defined herein.

As explained above, the individual compounds present in the composition of the present invention may themselves be derived from a natural source. However, whilst such naturally derived compounds may be obtained and purified and then added to the composition of the present invention, this does not result in the synthetic composition itself being an extract.

Furthermore, the synthetic composition of the present invention may be prepared by distributing components A, B, C, D and/or in a suitable solvent. In this regard, a suitable solvent may be ethanol or diethyl ether. It should be noted that the use of a solvent to assist in the preparation of the synthetic composition is optional and merely facilitates the production of the synthetic composition rather than having an impact on the aroma produced by the synthetic composition. In this regard, the solvent used would typically be such that it has evaporated from the synthetic composition before a user is able to even perceive its presence from an olfactory standpoint.

Accordingly, in a further aspect the present invention relates to the use of a synthetic composition as defined herein to simulate a tobacco aroma.

In one embodiment, the invention relates to the use of a synthetic composition, consisting essentially of components falling within components A, B, C, and D as defined herein, to simulate a tobacco aroma.

In a further aspect of the present invention, there is provided a formulation comprising the synthetic composition as defined herein, further comprising at least one of:
nicotine; and/or
a carrier.

The nicotine present in the formulation may be in protonated and/or un-protonated form. In one embodiment, the formulation comprises nicotine in unprotonated form and nicotine in monoprotonated form. Although it is envisaged that the formulation will typically comprise nicotine in unprotonated form and nicotine in monoprotonated form, it may be that small amounts of dipronoated nicotine are present. In one aspect the formulation comprises nicotine in unprotonated form, nicotine in monoprotonated form and nicotine in diprotonated form.

Reference to the wt % of constituents in the present formulation is with regard to the total weight of the formulation.

In one embodiment from 1 to 80 wt % of the nicotine present in the solution is in protonated form.

In one embodiment from 2 to 80 wt % of the nicotine present in the solution is in protonated form.

In one embodiment from 3 to 80 wt % of the nicotine present in the solution is in protonated form.

In one embodiment from 4 to 80 wt % of the nicotine present in the solution is in protonated form.

In one embodiment from 5 to 80 wt % of the nicotine present in the solution is in protonated form.

In one embodiment from 10 to 80 wt % of the nicotine present in the solution is in protonated form.

In one embodiment from 15 to 80 wt % of the nicotine present in the solution is in protonated form.

In one embodiment from 20 to 80 wt % of the nicotine present in the solution is in protonated form.

In one embodiment from 25 to 80 wt % of the nicotine present in the solution is in protonated form.

In one embodiment from 30 to 80 wt % of the nicotine present in the solution is in protonated form.

In one embodiment from 35 to 80 wt % of the nicotine present in the solution is in protonated form.

In one embodiment from 40 to 80 wt % of the nicotine present in the solution is in protonated form.

In one embodiment from 45 to 80 wt % of the nicotine present in the solution is in protonated form.

In one embodiment from 50 to 80 wt % of the nicotine present in the solution is in protonated form.

In one embodiment from 55 to 80 wt % of the nicotine present in the solution is in protonated form.

In one embodiment from 5 to 80 wt % of the nicotine present in the solution is in protonated form.

In one embodiment from 5 to 75 wt % of the nicotine present in the solution is in protonated form.

In one embodiment from 5 to 70 wt % of the nicotine present in the solution is in protonated form.

In one embodiment from 5 to 65 wt % of the nicotine present in the solution is in protonated form.

In one embodiment from 5 to 60 wt % of the nicotine present in the solution is in protonated form.

In one embodiment from 5 to 55 wt % of the nicotine present in the solution is in protonated form.

In one embodiment from 5 to 50 wt % of the nicotine present in the solution is in protonated form.

In one embodiment from 5 to 45 wt % of the nicotine present in the solution is in protonated form.

In one embodiment from 5 to 40 wt % of the nicotine present in the solution is in protonated form.

In one embodiment from 5 to 35 wt % of the nicotine present in the solution is in protonated form.

In one embodiment from 5 to 30 wt % of the nicotine present in the solution is in protonated form.

In one embodiment from 5 to 25 wt % of the nicotine present in the solution is in protonated form.

In one embodiment from 5 to 20 wt % of the nicotine present in the solution is in protonated form.

In one embodiment from 5 to 15 wt % of the nicotine present in the solution is in protonated form.

In one embodiment from 5 to 10 wt % of the nicotine present in the solution is in protonated form.

The relevant amounts of nicotine which are present in the formulation in protonated form are specified herein. These amounts may be readily calculated by one skilled in the art. Nicotine, 3-(1-methylpyrrolidin-2-yl) pyridine, is a diprotic base with pKa of 3.12 for the pyridine ring and 8.02 for the pyrrolidine ring. It can exist in pH-dependent protonated (mono- and di-) and non-protonated (free base) forms which have different bioavailability.

The distribution of protonated and non-protonated nicotine will vary at various pH increments.

The fraction of non-protonated nicotine will be predominant at high pH levels whilst a decrease in the pH will see an increase of the fraction of protonated nicotine (mono- or di- depending on the pH). If the relative fraction of protonated nicotine and the total amount of nicotine in the sample are known, the absolute amount of protonated nicotine can be calculated.

The relative fraction of protonated nicotine in solution can be calculated/estimated by using the Henderson-Hasselbalch equation, which describes the pH as a derivation of the acid dissociation constant equation, and it is extensively employed in chemical and biological systems. Consider the following equilibrium:

B+H⁺ [symbol] BH⁺

The Henderson-Hasselbalch equation for this equilibrium is:

$$pH = pKa + log \frac{[ B ]}{[ BH + ]}$$

Where [B] is the amount of non-protonated nicotine (i.e. free base), [BH+] the amount of protonated nicotine (i.e. conjugate acid) and pKa is the reference pKa value for the pyrrolidine ring nitrogen of nicotine (pKa=8.02). The relative fraction of protonated nicotine can be derived from the alpha value of the non-protonated nicotine calculated from the Henderson-Hasselbalch equation as:

$$\% protonated nicotine = 100 - \{ \frac{\frac{[ B ]}{[ BH + ]}}{\{ 1 + \frac{[ B ]}{[ BH + ]} \}} * 100 \}$$

Determination of pKa values of nicotine solutions can be carried out using the basic approach described in “Spectroscopic investigations into the acid-base properties of nicotine at different temperatures”, Peter M. Clayton, Carl A. Vas, Tam T. T. Bui, Alex F. Drake and Kevin McAdam, Anal. Methods, 2013, 5, 81-88.

As discussed herein the formulation may additionally comprise nicotine in unprotonated form and nicotine in protonated form. As will be understood by one skilled in the art, the protonated form of nicotine may be prepared by reacting unprotonated nicotine with an acid. The acid may be a compound from one component groups A, B, C and D. The acid(s) are one or more suitable acids, such as organic acids. In one embodiment, the acid is a carboxylic acid. The carboxylic acid may be any suitable carboxylic acid. In one embodiment, the acid is a mono-carboxylic acid.

In one embodiment, the acid is selected from the group consisting of acetic acid, benzoic acid, levulinic acid, lactic acid, formic acid, citric acid, pyruvic acid, succinic acid, tartaric acid, oleic acid, sorbic acid, propionic acid, phenylacetic acid, and mixtures thereof. In one embodiment, the acid is benzoic acid.

The carrier of the formulation may be any suitable solvent such that the formulation can be vaporised for use. In one embodiment the solvent is selected from glycerol, propylene glycol and mixtures thereof. In one embodiment the solvent is at least glycerol. In one embodiment the solvent consists essentially of glycerol. In one embodiment the solvent consists of glycerol. In one embodiment the solvent is at least propylene glycol. In one embodiment the solvent consists essentially of propylene glycol. In one embodiment the solvent consists of propylene glycol. In one embodiment the solvent is at least a mixture of propylene glycol and glycerol. In one embodiment the solvent consists essentially of a mixture of propylene glycol and glycerol. In one embodiment the solvent consists of a mixture of propylene glycol and glycerol.

The carrier of the formulation may be present in any suitable amount. In one embodiment the carrier is present in an amount of 1 to 98 wt % based on the formulation. In one embodiment the carrier is present in an amount of 5 to 98 wt % based on the formulation. In one embodiment the carrier is present in an amount of 10 to 98 wt % based on the formulation. In one embodiment the carrier is present in an amount of 20 to 98 wt % based on the formulation. In one embodiment the carrier is present in an amount of 30 to 98 wt % based on the formulation. In one embodiment the carrier is present in an amount of 40 to 98 wt % based on the formulation. In one embodiment the carrier is present in an amount of 50 to 98 wt % based on the formulation. In one embodiment the carrier is present in an amount of 60 to 98 wt % based on the formulation. In one embodiment the carrier is present in an amount of 70 to 98 wt % based on the formulation. In one embodiment the carrier is present in an amount of 80 to 98 wt % based on the formulation. In one embodiment the carrier is present in an amount of 90 to 98 wt % based on the formulation. In one embodiment the carrier is present in an amount of 1 to 90 wt % based on the formulation. In one embodiment the carrier is present in an amount of 5 to 90 wt % based on the formulation. In one embodiment the carrier is present in an amount of 10 to 90 wt % based on the formulation. In one embodiment the carrier is present in an amount of 20 to 90 wt % based on the formulation. In one embodiment the carrier is present in an amount of 30 to 90 wt % based on the formulation. In one embodiment the carrier is present in an amount of 40 to 90 wt % based on the formulation. In one embodiment the carrier is present in an amount of 50 to 90 wt % based on the formulation. In one embodiment the carrier is present in an amount of 60 to 90 wt % based on the formulation. In one embodiment the carrier is present in an amount of 70 to 90 wt % based on the formulation. In one embodiment the carrier is present in an amount of 80 to 90 wt % based on the formulation.

In a further aspect, the present invention relates to a container comprising a formulation as defined herein. The container may be any suitable container for retaining the formulation. For example, the container may be bottle. Further, the container may be a component of an aerosol delivery device or system, such as a cartomizer.

In a further aspect, the present invention relates to a method of producing an aerosol, said aerosol simulating a tobacco aroma, the method comprising the step of aerosolising a composition or formulation as defined herein.

In a further aspect, the present invention relates to the use of the formulation defined herein for simulating a tobacco aroma.

The present invention will now be described with reference to the following non-limiting examples.

### EXAMPLES

The compounds used in the preparation of exemplary synthetic compositions of the invention are given in Table 1. For the preparation of the synthetic compositions, stock solutions of compounds in ethanol were prepared. As explained above, the use of a solvent such as ethanol is not limiting on the invention and indeed other solvents, or indeed no solvent, could be used.

TABLE 1
Compounds used for synthetic compositions

| Compounds | Supplier | CAS |
|---|---|---|
| acetic acid | Sigma-Aldrich | 64-19-7 |
| 3-methylbutanoic acid | Sigma-Aldrich | 503-74-2 |
| 2-methylbutanoic acid | Sigma-Aldrich | 116-53-0 |
| 3-methyl-2,4-nonanedione | Penta Manufacturing | 113486-29-6 |
| β-damascone | Penta Manufacturing | 23726-92-3 |
| 2-methoxyphenol | Sigma-Aldrich | 90-05-1 |
| β-damascenone | Penta Manufacturing | 23726-91-2 |
| β-ionone | Sigma-Aldrich | 14901-07-6 |
| 4-methyl-2-methoxyphenol | Sigma-Aldrich | 93-51-6 |
| 3-hydroxy-2-methyl-4-pyrone | Sigma-Aldrich | 118-71-8 |
| 4-propyl-2-methoxyphenol | Sigma-Aldrich | 2785-87-7 |
| 3-hydroxy-4,5-dimethyl-2(5H)- | Sigma-Aldrich | 28664-35-9 |
| furanone | | |
| 2,6-dimethoxyphenol | Sigma-Aldrich | 91-10-1 |
| phenylacetic acid | Sigma-Aldrich | 103-82-2 |
| α-ionone | Sigma Aldrich | 127-41-3 |
| α-damascone | Penta Manufacturing | 43052-87-5 |
| β-cyclocitral | Sigma Aldrich | 432-25-7 |
| safranal | Sigma Aldrich | 116-26-7 |
| Ethyl maltol | Sigma Aldrich | 4940-11-8 |
| cyclotene | Sigma Aldrich | 765-70-8 |
| Ethyl cyclotene | Sigma Aldrich | 21835-01-8 |
| coronol | Sigma Aldrich | 13494-07-0 |
| mesifurane | Sigma Aldrich | 4077-47-8 |
| maple furanone | Sigma Aldrich | 698-10-2 |
| Benzaldehyde | Sigma Aldrich | 100-52-7 |
| α-ionol | AldrichCPR | 25312-34-9 |
| 4-allyl-2,6-dimethoxyphenol | Sigma-Aldrich | 6627-88-9 |

### Experimental 1

Preparation of Composition with a Tobacco-Like Aroma

Synthetic compositions comprising the compounds described in Table 2 were prepared in ethanol.

In particular, stock solutions of individual compounds were prepared in ethanol or diethyl ether. For the final formulation certain aliquots of each stock solution were combined and brought up to a defined volume to achieve the target concentrations. Various compositions were prepared as detailed in Table 2.

TABLE 2

| | Compound | | | | Comparative | Comparative |
|---|---|---|---|---|---|---|
| Compound | group | Example 1 | Example 2 | Example 3 | Example 1 | Example 2 |
| acetic acid | A | X | X | X | X | X |
| 3-methylbutanoic acid | A | | | X | | X |
| 3-methylpentanoic | A | | | X | | |
| acid | | | | | | |
| (E)-β-damascenone | B | X | X | X | X | |
| beta-damascone | B | | | | X | |
| beta-ionone | B | | | X | X | |
| Maltol | C | X | X | X | | X |
| sotolone | C | X | | X | | X |
| 2-methoxyphenol | D | | | X | X | |
| 4-methyl-2- | D | | | X | X | |
| methoxyphenol | | | | | | |
| 4-propyl-2- | D | | | X | X | |
| methoxyphenol | | | | | | |
| 2,6-dimethoxyphenol | D | X | X | X | | X |
| phenylacetic acid | D | X | X | X | | X |
| 3-methyl-2,4- | | | | | X | |
| nonandione | | | | | | |
| Tobacco like aroma | | ◯ | ◯ | ◯ | Δ | Δ |

The synthetic compositions were subjected to sensory analysis, according to the following protocol:
Set-up: samples of four tobacco samples (mixture of approx. 1 g of each of the four tobaccos) placed on round filter paper.
   200 μL of the synthetic composition was pipetted on extra round filter paper and →wave until ethanol is evaporated (no more visible wet spot on filter paper)
   Five panelists compared the tobacco samples and synthetic composition orthonasally
Result: 3 out of 5 panelists indicated that synthetic composition was reminiscent of tobacco—O
   Less than 3 out of 5 panelists indicated that synthetic composition was not reminiscent of tobacco—ΔA

As can be seen, it has been surprisingly found that a synthetic composition can be prepared which does not have to be extracted from tobacco yet which provides an aroma which is reminiscent of tobacco.

A suitable reference tobacco sample for testing the reminiscence of the synthetic composition includes tobacco from a “Rothmans Blue” cigarette (as supplied by British American Tobacco).

### Experimental 2

Preparation of Further Compositions with a Tobacco-Like Aroma

Synthetic compositions comprising the compounds described in Table 3 were prepared in ethanol.

In particular, stock solutions of all aroma compounds in diethyl ether (distilled) were prepared. The stock solutions had concentrations of approx. 1 mg/mL. Acetic acid and maltol were weighed directly. For the final formulation certain aliquots of each stock solution were combined and brought up to a defined volume with ethanol to achieve the target concentrations. Various compositions were prepared as detailed in Table 3.

TABLE 3

| | | Group | Con- | Tobacco- |
|---|---|---|---|---|
| | | (A, B, | centration | like |
| Example No. | Compound | C, D) | [μg/10 mL] | character |
| 4 (repetition | acetic acid | A | 36434.00 | ◯ |
| of | β-damascenone | B | 22.10 | |
| Example 2) | maltol | C | 1832.00 | |
| | phenylacetic acid | D | 631.00 | |
| | 2,6-dimethoxyphenol | D | 2258.00 | |
| Comparative | — | | — | Δ |
| Example 3 | β-damascenone | B | 22.10 | |
| | maltol | C | 1832.00 | |
| | phenylacetic acid | D | 631.00 | |
| | 2,6-dimethoxyphenol | D | 2258.00 | |
| 5 | 2-methylbutanoic acid | A | 22.60 | ◯ |
| | β-damascenone | B | 22.10 | |
| | maltol | C | 1832.00 | |
| | phenylacetic acid | D | 631.00 | |
| | 2,6-dimethoxyphenol | D | 2258.00 | |
| 6 | acetic acid | A | 36434.00 | ◯ |
| | α-ionone | B | 100.00 | |
| | maltol | C | 1832.00 | |
| | phenylacetic acid | D | 631.00 | |
| | 2,6-dimethoxyphenol | D | 2258.00 | |
| 7 | acetic acid | A | 36434.00 | ◯ |
| | β-cyclocitral | B | 100.00 | |
| | maltol | C | 1832.00 | |
| | phenylacetic acid | D | 631.00 | |
| | 2,6-dimethoxyphenol | D | 2258.00 | |
| 8 | acetic acid | A | 36434.00 | ◯ |
| | safranal | B | 100.00 | |
| | maltol | C | 1832.00 | |
| | phenylacetic acid | D | 631.00 | |
| | 2,6-dimethoxyphenol | D | 2258.00 | |
| 9 | acetic acid | A | 36434.00 | ◯ |
| | β-damascenone | B | 22.10 | |
| | ethylmaltol | C | 1000.00 | |
| | phenylacetic acid | D | 631.00 | |
| | 2,6-dimethoxyphenol | D | 2258.00 | |
| 10 | acetic acid | A | 36434.00 | ◯ |
| | β-damascenone | B | 22.10 | |
| | cyclotene | C | 100.00 | |
| | phenylacetic acid | D | 631.00 | |
| | 2,6-dimethoxyphenol | D | 2258.00 | |
| 11 | acetic acid | A | 36434.00 | ◯ |
| | β-damascenone | B | 22.10 | |
| | ethylcyclotene | C | 500.00 | |
| | phenylacetic acid | D | 631.00 | |
| | 2,6-dimethoxyphenol | D | 2258.00 | |
| 12 | acetic acid | A | 36434.00 | ◯ |
| | β-damascenone | B | 22.10 | |
| | coronol | C | 500.00 | |
| | phenylacetic acid | D | 631.00 | |
| | 2,6-dimethoxyphenol | D | 2258.00 | |
| 13 | acetic acid | A | 36434.00 | ◯ |
| | β-damascenone | B | 22.10 | |
| | mesifurane | C | 50.00 | |
| | phenylacetic acid | D | 631.00 | |
| | 2,6-dimethoxyphenol | D | 2258.00 | |
| 14 | acetic acid | A | 36434.00 | ◯ |
| | β-damascenone | B | 22.10 | |
| | maple furanone | C | 0.22 | |
| | phenylacetic acid | D | 631.00 | |
| | 2,6-dimethoxyphenol | D | 2258.00 | |
| 15 | acetic acid | A | 36434.00 | ◯ |
| | β-damascenone | B | 22.10 | |
| | maltol | C | 1832.00 | |
| | benzaldehyde | D | 150.00 | |
| | 2,6-dimethoxyphenol | D | 2258.00 | |
| 16 | acetic acid | A | 36434.00 | ◯ |
| | β-damascenone | B | 22.10 | |
| | maltol | C | 1832.00 | |
| | 2-methoxyphenol | D | 87.81 | |
| | 2,6-dimethoxyphenol | D | 2258.00 | |
| 17 | acetic acid | A | 36434.00 | ◯ |
| | β-damascenone | B | 22.10 | |
| | maltol | C | 1832.00 | |
| | phenylacetic acid | D | 631.00 | |
| | 4-allyl-2,6- | D | 252.00 | |
| | dimethoxyphenol | | | |
| 18 | acetic acid | A | 36434.00 | ◯ |
| | β-damascenone | B | 22.10 | |
| | maltol | C | 1832.00 | |
| | phenylacetic acid | D | 631.00 | |
| | 2-methoxyphenol | D | 88.00 | |
| 19 | acetic acid | A | 36434.00 | ◯ |
| | α-ionol | B | 22.10 | |
| | maltol | C | 1832.00 | |
| | phenylacetic acid | D | 631.00 | |
| | 2,6-dimethoxyphenol | D | 2258.00 | |
| Comparative | acetic acid | A | 36434.00 | Δ |
| Example 4 | — | | — | |
| | maltol | C | 1832.00 | |
| | phenylacetic acid | D | 631.00 | |
| | 2,6-dimethoxyphenol | D | 2258.00 | |
| Comparative | acetic acid | A | 36434.00 | Δ |
| Example 5 | β-damascenone | B | 22.10 | |
| | — | | — | |
| | phenylacetic acid | D | 631.00 | |
| | 2,6-dimethoxyphenol | D | 2258.00 | |
| Comparative | acetic acid | A | 36434.00 | Δ |
| Example 6 | β-damascenone | B | 22.10 | |
| | maltol | C | 1832.00 | |
| | — | | — | |
| | 2,6-dimethoxyphenol | D | 2258.00 | |
| Comparative | acetic acid | A | 36434.00 | Δ |
| Example 7 | β-damascenone | B | 22.10 | |
| | maltol | C | 1832.00 | |
| | — | | — | |
| | — | | — | |

### Sensory Protocol

A sensory testing protocol was devised and is described below.

200 microliters of each test blend (each example) was added to a cellulose based filter paper to prepare the test sample. The test sample was then presented to panelists for odour assessment. The samples were randomized and positive and negative control samples were included in the test design and presented blind to the panelists.

Additionally, four tobaccos were presented to the panelists to provide different references of natural tobacco aroma.

Five panelists were used for the assessment, and individual and consensus scores and descriptors were recorded during the sensory paneling.

Test samples were compared with reference tobacco samples.

As in Experiment 1, the synthetic composition was rated to be as tobacco-like if three or more of the five panelists described the sample as tobacco-like.

A suitable reference tobacco sample for testing the reminiscence of the synthetic composition includes tobacco from a “Rothmans Blue” cigarette (as supplied by British American Tobacco).

### RESULTS AND DISCUSSION

It can be in the above that removal of a compound from group A leads to a loss of tobacco-like aroma (see comparison between Comparative Example 3 and Example 2 or Example 4). Further, representative acids which can be used as a compound from group A are acetic acid and 2-methylbutanoic acid.

Further, it can be seen that the removal of a compound from group B leads to a loss of tobacco-like aroma (see comparison between Comparative Example 4 and Example 2 or Example 4). Further, representative compounds which can be used as a compound from group B are β-Damascenone, β-Cyclocitral, Safranal, α-ionol and β-ionone.

Further, it can be seen that the removal of a compound from group C leads to a loss of tobacco-like aroma (see comparison between Comparative Example 5 and Example 2 or Example 4). Further, representative compounds which can be used as a compound from group C are maltol, ethyl maltol, cyclotene, ethyl cyclotene, mesifurane, maple furanone, maple furanone, and coronol.

Further, it can be seen that the removal of a compound from group D leads to a loss of tobacco-like aroma (see comparison between Comparative Examples 6 and 7 with Example 2 or Example 4). Further, representative compounds which can be used as a compound from group D are phenyl acetic acid, benzaldehyde, 2-methoxyphenol, and 2,6-dimethoxyphenol.

In view of the above, it has surprisingly been found that a synthetic composition comprising compounds from each of groups A, B, C and D are preferred when preparing compositions which have an aroma reminiscent of tobacco.

In order to address various issues and advance the art, the entirety of this disclosure shows by way of illustration various embodiments in which the claimed invention(s) may be practiced and provide for superior synthetic compositions which have an aroma reminiscent of tobacco. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. In addition, the disclosure includes other inventions not presently claimed, but which may be claimed in future.

1. A synthetic composition comprising at least one compound from each of components A, B, C, and D wherein:
A is at least one compound of formula I 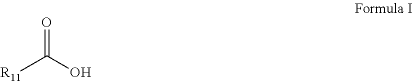
wherein R₁₁ is a saturated —C₁-C₆ hydrocarbon group; and
wherein at least one compound of component A is acetic acid;
B is at least one compound of formula II 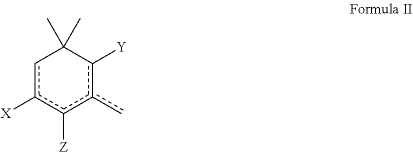
wherein Y is a group selected from —R₉(C═O)R₁₀, or a saturated or unsaturated —C₁-C₆ hydrocarbon group optionally substituted with one or more hydroxyl groups;
R₉ is a bond or a saturated or unsaturated —C₁-C₆ hydrocarbon group;
R₁₀ is —H or a saturated or unsaturated —C₁-C₆ hydrocarbon group;
Z and X are both independently selected from —H and —R₃;
R₃ is selected from a saturated or unsaturated —C₁-C₆ hydrocarbon group, a keto group, or -L-(C═O)R₁₃,
L is either a bond or —C₁-C₆ hydrocarbon group,
R₁₃ is a saturated or unsaturated —C₁-C₆ hydrocarbon group;
C is at least one compound of formula IIIb 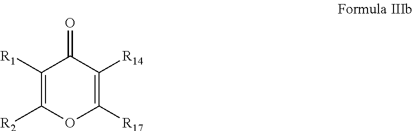
R₁ is —OH, —C₁-C₆-alkoxy, or —OCOR₁₂;
R₁₂ is a saturated or unsaturated —C₁-C₆ hydrocarbon group;
R₂ and R₁₄ are independently selected from H and an optionally substituted saturated or unsaturated —C₁-C₆ hydrocarbon group;
R₁₇ is H or a saturated or unsaturated —C₁-C₆ hydrocarbon group;
D is at least one compound of formula IV 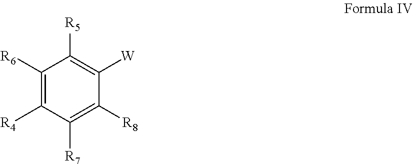
wherein W is —OH, —C₁-C₆—OH, —(C═O)H, —C₁-C₃—(C═O)H, —O(C═O)H, —O(C═O)CH₃, C₁-C₆ alkoxy or —R₁₅(C═O)OR₁₆;
R₁₅ is a saturated or unsaturated —C₁-C₆ hydrocarbon group;
R₁₆ is —H or a saturated or unsaturated —C₁-C₆ hydrocarbon group;
R₄ to R₈ are each independently —H, —OH, C₁-C₆ alkoxy, or a saturated or unsaturated —C₁-C₆ hydrocarbon group; and
wherein at least one compound of component D is a compound of formula IV, wherein W is —OH, —C₁-C₆—OH, —C₁-C₃—(C═O)H, —O(C═O)H, —O(C═O)CH₃, C₁-C₆ alkoxy or —R₁₅(C═O)OR₁₆.

2. The synthetic composition according to claim 1, wherein R₁₁ is a linear —C₁-C₆ hydrocarbon group, or a branched —C₁-C₆ hydrocarbon group.

3. (canceled)

4. The synthetic composition according to claim 1, wherein A a) is at least two different compounds of formula 1; or b) is at least three different compounds of formula I; or c) is at least acetic acid and/or 2-methylbutanoic acid and/or 3-methylbutanoic acid.

5.-6. (canceled)

7. A The synthetic composition according to claim 1, wherein B a) is at least of formula IIa 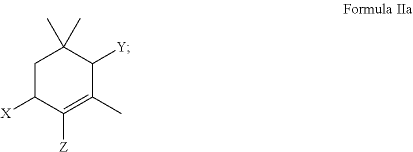
or b) is of formula IIa, X is R₃, Z is —H, and R₁₃ is an unsaturated —C₃ hydrocarbon group; or c) is of formula IIa, Z is R₃, X is —H, and R₁₃ is an unsaturated —C₃ hydrocarbon group; or d) is at least of formula IIa and Y is an unsubstituted saturated or unsaturated —C₁-C₆ hydrocarbon group substituted with one or more hydroxyl groups, X is —R₃ where —R₃ is a keto group, and Z is —H.

8. The synthetic composition according to claim 1, wherein B a) is at least of formula IIb 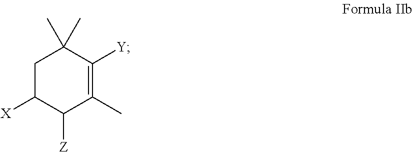
or b) is of formula IIb, X is R₃, Z is —H, and R₁₃ is an unsaturated —C₃ hydrocarbon group; or c) is of formula IIb, X is R₃, Z is —H, and R₁₃ is a —CH═CHCH₃ group; or d) is of formula IIb, Z is R₃, X is —H, and R₁₃ is an unsaturated —C₃ hydrocarbon group.

9. The synthetic composition according to claim 1, wherein B a) is at least of formula IIc 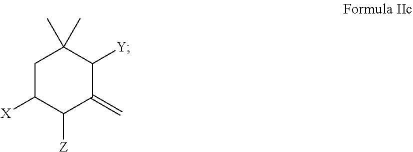
or b) is of formula IIc, X is R₃, Z is —H, and R₁₃ is an unsaturated —C₃ hydrocarbon group; or c) is of formula IIc, Z is R₃, X is —H, and R₁₃ is an unsaturated —C₃ hydrocarbon group.

10. The synthetic composition according to claim 1, wherein B a) is at least of formula IId 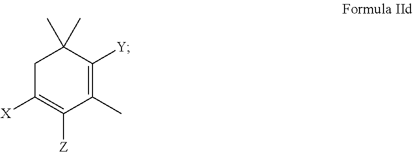
or b) is of formula IId, X is R₃, Z is —H, and R₁₃ is an unsaturated —C₃ hydrocarbon group; or c) is of formula IId, X is R₃, Z is —H, and R₁₃ is a —CH═CHCH₃ group; or d) is of formula IId, Z is R₃, X is —H, and R₁₃ is an unsaturated —C₃ hydrocarbon group.

11. A The synthetic composition of claim 1, wherein a) X is —R₃ and Z is —H; or b) Z is —R₃ and X is —H; or c) both Z and X are —H.

12.-13. (canceled)

14. The synthetic composition according to claim 1, wherein R₁₃ is a —CH═CHCH₃ group.

15.-22. (canceled)

23. The synthetic composition according to claim 1, wherein Y a) is —R₉(C═O)R₁₀, R₉ is a bond and R₁₀ is an unsaturated —C₁-C₆ hydrocarbon group; or b) is a saturated or unsaturated —C₁-C₆ hydrocarbon group substituted with one or more hydroxyl groups; or c) is an unsubstituted saturated or unsaturated —C₁-C₆ hydrocarbon group.

24.-26. (canceled)

27. The synthetic composition according to claim 1, wherein B is at least two different compounds of formula II.

28. The synthetic composition according to claim 1, wherein R₁ is —OCOR₁₂, wherein R₁₂ is a C₂ alkyl or C₃ alkyl, and R₂ is —CH₃.

29. The synthetic composition according to claim 1, wherein component C is at least two different compounds of formula III.

30. The synthetic composition according to claim 1, wherein W is —R₁₅(C═O)OR₁₆.

31. The synthetic composition according to claim 1, wherein W is —OH.

32. The synthetic composition according to claim 9, wherein B is of formula IIc, Z is R₃, X is —H, and R₁₃ is an unsaturated —C₃ hydrocarbon group and W is —OH, and at least one of R₄ to R₈ is C₁-C₆ alkoxy.

33. The synthetic composition according to claim 1, wherein the ratio of component A:B for those component A components where R₁₁ is not methyl, is from 1 to 25:1.

34. A method of simulating tobacco aroma comprising producing a composition as defined in claim 1 and simulating a tobacco aroma.

35. A formulation comprising the synthetic composition as defined in claim 1, wherein the formulation further comprises at least one of:
nicotine; and/or
a carrier.

36. The formulation according to claim 35, wherein formulation comprises nicotine and a carrier, and the carrier is a solvent selected from glycerol, propylene glycol and mixtures thereof.

37. A container comprising a formulation as defined in claim 35.

38. The container of claim 37, wherein the container is a bottle.

39. The container of claim 37, wherein the container is a component of an aerosol delivery device.

40. A method of preparing a synthetic composition as defined in claim 1, the method comprising the step of combining at least one compound from each of components A, B, C, and D as defined herein, wherein at least one of the compounds did not originate from a tobacco extract.

41. A method of producing an aerosol, said aerosol simulating a tobacco aroma, the method comprising the step of aerosolising a composition selected from the group consisting of the composition as defined in claim 1, or a formulation of claim 35.
